(19) United States
(12) Patent Application Publication
(10) Pub. No.: US 2010/0009185 A1
(43) Pub. Date: Jan. 14, 2010

(54) Enameled wire containing a nano-filler

(75) Inventors: Tsang-Tse Fang, Tainan City (TW); Steve Lien-Chung Hsu, Tainan City (TW); Hsing-I Hsiang, Tainan City (TW); Han-Yang Chung, Jhongli City (TW); Ting-I Lu, Rende Hsiang (TW); Chih-Wei Hsu, Fongshan City (TW); Chun-Hung Chen, Tainan City (TW); Jung-Kun Chiu, Tainan City (TW); Shang-Hui Shen, Tainan Hsien (TW)

Correspondence Address: COOPER & DUNHAM, LLP, 30 Rockefeller Plaza, 20th Floor, NEW YORK, NY, 10112, US

(73) Assignee: Ta Ya Electric Wire & Cable Co., Ltd.

(21) Appl. No.: 12/218,292

(22) Filed: Jul. 14, 2008

(51) Int. Cl. B32B 15/02; B32B 17/12

(52) U.S. Cl. 428/388

(57) ABSTRACT

An enameled wire containing a nano-filler includes a metallic wire and at least one layer of insulating coating. At least one layer of the at least one layer of insulating coating includes a nano-filler. The nano-filler is a modified silicon dioxide slurry comprising silicon dioxide, organic solvent and organic silane coupling agent. The nano-filler comprises silicon dioxide modified with an organic silane coupling agent to improve dispersion of the nano-filler and maintain properties of the insulating coating. In addition, material and manufacturing costs of the enameled wire can be lowered.

### BACKGROUND OF THE INVENTION

1. Field of Invention

The present invention relates to an enameled wire, and more particularly to an enameled wire containing a nano-filler comprising highly dispersed silicon dioxide.

2. Description of the Related Art

Inorganic fillers are often added to polymers to reinforce some properties of polymers and provide new functions. A reinforcing effect of the inorganic fillers is usually related to a size of the fillers and a dispersion of the fillers through the polymers. Fillers with a smaller size disperse in polymers better and provide a higher reinforcing effect.

Applications of nano-fillers on polymers have become an interesting research topic since a composite material of nano-clay/nylon 6 was reported. The nano-fillers can be applied on a rubber composite material to improve an abrasion resistance and gas barrier properties, and develop a halogen-free flame-retardant material. The nano-fillers can also be added to synthetic fibers to provide anti-bacteria, aging-resistant, uvioresistant or infrared absorption functions. In the paint and coatings industry, nano-fillers are used to develop functional coatings with a high resistance to weathering, good abrasion-resistance, self-cleansing or absorption of electromagnetic waves.

The nano-fillers have been applied to wires and cable. For example, nano metal oxides have been added to an insulating coating of enameled wires to increase corona-resistance. However, the metallic nano-fillers are easy to aggregate and form micro or sub-micro particles. When the metallic nano-fillers aggregate in polymers, a compatibility and dispersity of the nano-fillers will be lowered and applications of the nano-fillers are limited.

U.S. Pat. Nos. 4,493,873, 4,503,124, 4,537,804 and 4,546,041 disclosed an enamel composition comprising from 15% to 35% by weight of alumina particles of a finite size less than 100 nm. The alumina particles are dispersed in an insulating resin by high shear mixing and the insulating resin can be used to make a corona-resistant wire. However, the wires must be manufactured by two-stage coating to achieve better appearance and properties.

U.S. Pat. Nos. 5,917,155 and 6,056,995 disclosed a corona-resistant insulation layer used for coating an electrical conductor comprising 10 to 50 parts by weight of alumina particles dispersed in 100 parts by weight of a polymeric binder and a coloring agent comprising titanium dioxide. The alumina and titanium dioxide particles have a size in a range from about 5 to 250 nm. When the electrical conductor is coated, the insulation layer is sandwiched between two other layers.

U.S. Pat. No. 6,190,770 and U.S. Pub. No. 2002/0197473 disclosed that corona-resistance of enameled wires is improved with the addition of alumina particles. Because alumina particles have two major structures (α-form and β-form), the patents indicated that alumina particles with a specific ratio of α-form to β-form can achieve a better result.

U.S. Pat. No. 6,100,474 disclosed a mixture of fumed silica and chromium oxide dispersed in polyamide-imide as the topcoat layer of a polyester-based enameled wire. The mixture provides resistance to degradation of the insulation as a result of high voltage and high frequency wave forms passing through the electrical conductor. The fumed silica has a particle size in a range from about 250 m²/g to about 550 m²/g.

The foregoing patents tried to improve corona-resistance of an insulating coating with the addition of metal oxides by high shear mixing or grinding. However, nano-fillers are very easy to aggregate due to a high surface energy and are difficult to disperse evenly in the insulating coating having a high viscosity and solid content. Therefore, the insulating coating may have a low stability and cannot be stored for a long time. Enameled wires with the insulating coating may also have low mechanical properties. The insulating coating is also hard to be coated directly on wires and must be coated in a multi-layer manner.

In order to solve the aggregation problem, U.S. Pat. No. 6,811,875 disclosed an application of a gel comprising nano-fillers of zirconia, alumina and silica. The nano-fillers are dispersed in solvents to form a gel and then added to an insulating coating. Thus, the insulating coating can be used to manufacture an enameled wire with a partial discharge resistance. However, the insulating coating has a high friction coefficient and must be coated with a lubricant polyamide-imide overcoat layer to facilitate the winding of the enameled wire.

Dispersing agents are used to disperse fine particles in a continuous phase for acquiring a stable suspension. Dispersing agents are generally surfactants that can prevent the fine particles from aggregating in the continuous phase. Choosing dispersing agents for different nano-fillers and insulating coatings is complicated and no dispersing agent is known to be suitable for all dispersing systems. Accordingly, utilizing suitable dispersing agents is important for nano-fillers applied to insulating coating. U.S. Pat. No. 6,190,770 had mentioned a technique of adding dispersing agent to prevent aggregation, but failed to disclose the practical application.

To overcome the shortcomings, the present invention provides an enameled wire containing a nano-filler to mitigate or obviate the aforementioned problems.

### SUMMARY OF THE INVENTION

The primary objective of the present invention is to provide an enameled wire containing a nano-filler comprising highly dispersed silicon dioxide.

An enameled wire containing a nano-filler in accordance with the present invention comprises a metallic wire and at least one layer of insulating coating. At least one layer of the at least one layer of insulating coating comprises a nano-filler. The nano-filler is a modified silicon dioxide slurry comprising silicon dioxide, organic solvent and an organic silane coupling agent.

The silicon dioxide has a primary particle size of 15 nm and is therefore is easy to aggregate to form micro particles due its high surface energy. Thus, silicon dioxide is modified with an organic silane coupling agent to ensure high dispersion.

The enameled wire in accordance with the present invention uses the organic silane coupling agent to improve adhesive properties. The organic silane coupling agent is often applied to a solvent-based surface coating. When the organic silane coupling agent is applied to the insulating coating of the enameled wire, the adhesive properties of the insulating coating can be increased. In addition, because the organic silane coupling agent has polar and non-polar functional groups, it can be used as a surfactant to disperse silicon dioxide in the insulating coating. Thus, the modified silicon dioxide is well mixed in the insulating coating.

Furthermore, silicon dioxide as a filler is cheaper than other nano metal oxides. Silicon dioxide can be used in small amounts so as to further reduce a material cost of the enameled wire. The insulating coating can maintain its original properties due to the usage of the small amounts of silicon dioxide and need not to contain other additives to adjust solid content and viscosity. The enameled wire can maintain properties of the insulating coating. Original manufacturing processes of the enameled wire also need not to be changed so manufacturing the enameled wire is convenient, does not require retooling but has the aforementioned advantages without dramatically increased costs.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional view of a first embodiment of an enameled wire containing a nano-filler in accordance with the present invention;

FIG. 2 is a cross-sectional view of a second embodiment of the enameled wire containing a nano-filler in accordance with the present invention; and

FIG. 3 is a cross-sectional view of a third embodiment of the enameled wire containing a nano-filler in accordance with the present invention.

### DETAILED DESCRIPTION OF THE INVENTION

An enameled wire containing a nano-filler in accordance with the present invention comprises a metallic wire and at least one layer of insulating coating.

The metallic wire may be a round or flat bare copper wire, copper clad aluminum wire, aluminum wire or other alloy wire.

The at least one layer of insulating coating layer is disposed around the metallic wire and may comprise a synthetic resin. The synthetic resin may be polyester resin, polyimide resin, polyurethane resin, polyamide imide resin or polyesterimide resin. At least one layer of the at least one layer of insulating coating comprises a nano-filler. The nano-filler is a modified silicon dioxide slurry and comprises 1 part by weight of silicon dioxide, 10 to 20 parts by weight organic solvent and 0.2 to 0.6 parts by weight of organic silane coupling agent.

Preferably, the silicon dioxide has a specific surface area of 100 to 500 m²/g.

The organic solvent may be phenols, hydrocarbon solvent, amides, esters, ketones, alcohols or a mixture thereof. The phenols may be phenol, cresol or xylenol. The amides may be N-methyl-2-pyrrolidone (NMP) or N,N-dimethyl acetamide (DMA).

The organic silane coupling agent may have the following general structure formula,

R¹—(CH₂)m-X—(CH₂)n-Si—(O—R²)₃

wherein R¹ is methyl, amino, epoxy, vinyl or methacryl; R² is hydrogen, methyl or ethyl; X is CH₂ or O; m is 0 or 1; n is 0, 1, 2 or 3.

The modified silicon dioxide slurry may be prepared by the following processes:

1. adding 1 part by weight of silicon dioxide to 10 to 20 parts by weight of organic solvent to form a solution and agitating the solution at a temperature of 20 to 30° C. to disperse silicon dioxide.

2. adding 0.2 to 0.6 parts by weight of organic silane coupling agent to the solution, adjusting the solution to a pH value between 2 and 6 and reacting at a temperature of 20 to 40° C. for 3 to 10 hours to acquire a modified silicon dioxide slurry.

The insulating coating comprising the nano-filler can be prepared by adding the modified silicon dioxide slurry comprising 1 part by weight of silicon dioxide to 25 to 100 parts by weight of synthetic resin and agitating the insulating coating with a homogenizer at a temperature of 20 to 30° C. for 1 to 2 hours.

The enameled wire in accordance with the present invention has good mechanic and insulating properties and can be applied to a frequency conversion motor.

The following examples further illustrate the present invention but are not to be construed as limiting the invention as defined in the claims appended hereto. All parts given in these examples are by weight unless otherwise indicated.

### (1) MATERIALS AND EQUIPMENTS USED

1. Polyurethane resin: Terebec® (MT533-39 produced by ELANTAS (Tongling) Co., Ltd., viscosity 2.5 Pa·S at 25° C., solid content 39%.

2. Polyester resin: FUPAO® LITON-3338ST, produced by FuPao Chemical Co., Ltd., Taiwan, viscosity 1.7 Pa·S at 30° C., solid content 38%.

3. Polyimide resin: FUPAO® NH-AI-32P, produced by FuPao Chemical Co., Ltd., Taiwan, viscosity 1.0 Pa·S at 30° C., solid content 32%.

4. Silicon dioxide: CAB-O-SIL® M-5 produced by Cabot Corporation, USA, specific surface area 200 m²/g, average primary particle size 15 nm.

5. Homogenizer: IKA® T50, produced by IKA works, Germany, speed 4000 to 10 000 rpm.

### (2) EXAMPLES

### 1. Comparison Example 1

### Example C1

A layer of polyesterimide was coated on a copper wire (0.50 mm diameter) under the following conditions:

Coating type: dies

Coatings passes: 7 to 10 passes

Coating speed: 20 to 30 m/min

Oven temperature: 450 to 520° C.

Properties of a product of Comparison Example 1 are shown in Table 1.

### 2. Comparison Example 2

### Example C2

3 parts of silicon dioxide were added to 100 parts of polyesterimide to form a solution and the solution was agitated with the homogenizer and then blended 5 times with a triple-roller mill. The solution was coated on a copper wire (0.50 mm diameter) like Comparison Example 1. Properties of a product of Comparison Example 2 are shown in Table 1.

### 3. Example 1

### 3.1 Preparation of a Modified Silicon Dioxide Slurry

1 part of silicon dioxide was added to 10 parts of organic solvent comprising ethanol, acetone, cresol, xylene and other hydrocarbon solvents to from a solution and the solution was agitated and well mixed at 20 to 30° C. 0.2 parts of 3-(2,3-Epoxy propoxyl) propyltrimethoxysilane was added to the solution and the solution was adjusted to a pH value of 6. The solution was reacted for 3 hours at 20 to 40° C. to form the modified silicon dioxide slurry.

### 3.2 Manufacture of an Enameled Wire Containing a Nano-Filler

The modified silicon dioxide slurry was added to 100 parts of polyesterimide to form an insulating coating and the insulating coating was agitated and well mixed with the homogenizer. The insulating coating was coated on a copper wire (0.50 mm diameter) like Comparison Example 1. Properties of a product of Example 1 are shown in Table 1.

### 4. Example 2

### 4.1 Preparation of a Modified Silicon Dioxide Slurry

2 parts of silicon dioxide were added to 30 parts of organic solvent comprising ethanol, acetone, cresol, xylene and other hydrocarbon solvent to from a solution and the solution was agitated and well mixed at 20 to 30° C. 0.8 parts of 3-(2,3-Epoxy propoxyl) propyltrimethoxysilane was added to the solution and the solution was adjusted to a pH value of 5. The solution was reacted for 5 hours at 20 to 40° C. to form the modified silicon dioxide slurry.

### 4.2 Manufacture of an Enameled Wire Containing a Nano-Filler

The modified silicon dioxide slurry was added to 100 parts of polyesterimide to form an insulating coating and the insulating coating was agitated and well mixed with the homogenizer. The insulating coating was coated on a copper wire (0.50 mm diameter) like Comparison Example 1. Properties of a product of Example 2 are shown in Table 1.

### 5. Example 3

### 5.1 Preparation of a Modified Silicon Dioxide Slurry

3 parts of silicon dioxide were added to 50 parts of organic solvent comprising ethanol, acetone, cresol, xylene and other hydrocarbon solvent to from a solution and the solution was agitated and well mixed. 1.5 parts of 3-(2, 3-Epoxy propoxyl) propyltrimethoxysilane were added to the solution and the solution was adjusted to a pH value of 5. The solution was reacted for 8 hours at 20 to 40° C. to form the modified silicon dioxide slurry.

### 5.2 Manufacture of an Enameled Wire Containing a Nano-Filler

The modified silicon dioxide slurry was added to 100 parts of polyesterimide to form an insulating coating and the insulating coating was agitated and well mixed with the homogenizer. The insulating coating was coated on a copper wire (0.50 mm diameter) like Comparison Example 1. Properties of a product of Example 3 are shown in Table 1.

TABLE 1⁽¹⁾

| Example | C1 | C2 | 1 | 2 | 3 |
|---|---|---|---|---|---|
| Appearance | Good | Rough | Good | Good | Good |
| Adherence | Good | Good | Good | Good | Good |
| Elongation (%) | 32.8 | 33.8 | 33.6 | 34.7 | 36.3 |
| Friction Coefficient | 0.05 | 0.075 | 0.05 | 0.055 | 0.05 |
| Unidirectional scrape | 952 | 866 | 960 | 996 | 1040 |
| resistance | | | | | |
| Repeated scrape | 48 | 68 | 84 | 216 | 272 |
| resistance | | | | | |
| Heat Shock | OK | 6/10 | OK | OK | OK |
| | | failure | | | |
| Softening Temperature | 337 | 359 | 340 | 364 | 373 |
| (° C.) | | | | | |
| Dielectric Breakdown | 7.11 | 10.77 | 8.29 | 9.98 | 12.90 |
| Voltage (kV) | | | | | |
| Pulsed voltage surge | 6 | 256 | 16 | 66 | 575 |
| lifetime (min)⁽²⁾ | | | | | |

Note:
⁽¹⁾Each property was tested according to the NEMA MW-30C standards.
⁽²⁾A specimen wire twisted in accordance with the dielectric breakdown voltage test and the specimen is disposed in 195° C. constant-temperature oven connected to a frequency converter. The frequency converter has an output voltage of 520 V, at a main frequency of 60 Hz, a carrier frequency of 15 kHz and a peak value of the carrier voltage of sinusoidal square carrier wave of 1.4 kV.

The results of Table 1 show that products using insulating coatings containing the modified silicon dioxide slurry have a better scrape-resistance, higher softening temperature, dielectric breakdown voltage and pulsed voltage surge lifetime. Modified silicon dioxide can be well mixed with synthetic resin and does not reduce the properties of insulating coatings. Products can exhibit good properties even with only one layer of insulating coating. Relatively speaking, the product using the insulating coating containing unmodified silicon dioxide exhibits a much lower scrape-resistance and heat shock resistance due to the incompatible unmodified silicon dioxide even though some other properties are improved.

### 6. Comparison Example 3

### Example C3

A layer of polyester was coated on a copper wire (0.50 mm diameter) like Comparison Example 1. Properties of a product of Comparison Example 3 are shown in Table 2.

### 7. Example 4

3 parts of silicon dioxide and 100 parts of polyester were used to form an insulating coating containing a modified silicon dioxide slurry like Example 3. The insulating coating was coated on a copper wire (0.50 mm diameter) like Comparison Example 1. Properties of a product of Example 4 are shown in Table 2.

TABLE 2⁽³⁾

| Example | C3 | 4 |
|---|---|---|
| Appearance | Good | Good |
| Adherence | Good | Good |
| Elongation (%) | 31.3 | 36.5 |
| Friction Coefficient | 0.05 | 0.05 |
| Unidirectional scrape resistance | 822 | 870 |
| Repeated scrape resistance | 66 | 104 |
| Heat Shock (A)⁽⁴⁾ | OK | OK |
| Heat Shock (B)⁽⁵⁾ | 6/10 failure | 1/10 failure |
| Softening Temperature (° C.) | 314 | 328 |
| Dielectric Breakdown Voltage (kV) | 8.02 | 10.43 |
| Pulsed voltage surge lifetime (min) | 11 | 94 |

Note:
⁽³⁾Each property was tested according to the NEMA MW-5C standard.
⁽⁴⁾Each specimen was wound around mandrel having a triple diameter of the enameled wire, and then heated for 1 hr at 150° C. according to the CNS 2183 standard.
⁽⁵⁾Each specimen was elongated by 20%, wound around mandrel having a triple diameter of the enameled wire, and then heated for 0.5 hr at 175° C. according to the NEMA MW-5C standard.

The results of Table 2 also show that the product using insulating coating containing the modified silicon dioxide slurry has better properties even with only one layer of insulating coating.

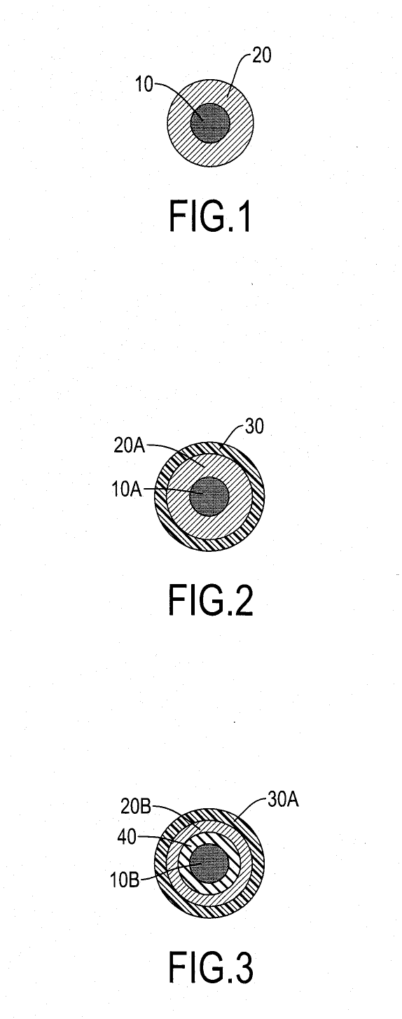

With reference to FIG. 1, a layer (20) of insulating coating containing a modified silicon dioxide slurry is disposed around a metallic wire (10) so as to form an enameled wire of one-layer structure.

With reference to FIG. 2, a first layer (20A) of insulating coating containing a modified silicon dioxide slurry is disposed around a metallic wire (10A). A second layer (30) of insulating coating is disposed around the first layer (20A) so as to form an enameled wire having two-layers.

With reference to FIG. 3, a first layer (40) of insulating coating is disposed around a metallic wire (10B). A second layer (20B) of insulating coating containing a modified silicon dioxide slurry is disposed around the first layer. A third layer (30A) of insulating coating is disposed around the second layer (20B) so as to form an enameled wire having three-layers.

The examples of the enameled wire in accordance with the present invention use silicon dioxide as a filler in the insulating coating. Because silicon dioxide used has an average primary particle size of 15 nm, silicon dioxide easily aggregates to form micro particles due to its high surface energy. Thus, silicon dioxide is modified with organic silane coupling agent to have high dispersion.

The examples of the enameled wire in accordance with the present invention use the organic silane coupling agent having methyl, amino, epoxy, vinyl or methacryl group in its long chain to modify nano silicon dioxide in organic solvent under acidic condition to form a modified silicon dioxide slurry. The modified silicon dioxide slurry has excellent dispersion and can be well mixed in an insulating coating with the agitation of a homogenizer for single or multi-layer coating. Additionally, adding only 1 to 4 parts of silicon dioxide to 100 parts of insulating coating can provide good improved properties. The enameled wire of single layer coating in accordance with the present invention has a good corona-resistance, elongation, scrape-resistance, high softening temperature, dielectric breakdown voltage and pulsed voltage surge lifetime.

Furthermore, silicon dioxide as a filler has an obvious cost advantage relative to other nano metal oxide. Silicon dioxide is much cheaper and can be used in small amounts. Moreover, preparation of the modified silicon dioxide slurry need not require complicated or expensive equipment, nor retooling. The insulating coating can maintain its original properties due to the usage of the small amount of silicon dioxide and need not the addition of other additives to adjust solid content and viscosity. Original manufacturing processes of the enameled wire also need not to be changed so manufacturing the enameled wire is convenient.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An enameled wire containing a nano-filler comprising
a metallic wire; and
at least one layer of insulating coating and at least one layer of the at least one layer of insulating coating comprising a nano-filler being a modified silicon dioxide slurry comprising
silicon dioxide;
organic solvent; and
organic silane coupling agent.

2. The enameled wire containing a nano-filler as claimed in claim 1, wherein the modified silicon dioxide slurry comprises
1 part by weight of silicon dioxide;
10 to 20 parts by weight of organic solvent; and
0.2 to 0.6 parts by weight of organic silane coupling agent.

3. The enameled wire containing a nano-filler as claimed in claim 2, wherein the organic silane coupling agent has the following structure:
R¹—(CH₂)m-X—(CH₂)n-Si—(O—R²)₃
wherein R¹ is methyl, amino, epoxy, vinyl or methacryl; R² is hydrogen, methyl or ethyl;
X is CH₂ or O;
m is 0 or 1; and
n is 0, 1, 2 or 3.

4. The enameled wire containing a nano-filler as claimed in claim 3, wherein the layer of insulating coating comprising the nano-filler is prepared by adding the modified silicon dioxide slurry comprising 1 part by weight of silicon dioxide to 25 to 100 parts by weight of synthetic resin.

5. The enameled wire containing a nano-filler as claimed in claim 4, wherein the organic solvent is phenols, hydrocarbon solvent, amides, esters, ketones, alcohols or a mixture thereof.

6. The enameled wire containing a nano-filler as claimed in claim 5, wherein phenols are phenol, cresol or xylenol and amides are N-methyl-2-pyrrolidone (NMP) or N,N-dimethyl acetamide (DMA).

7. The enameled wire containing a nano-filler as claimed in claim 6, wherein the synthetic resin is polyester resin, polyimide resin, polyurethane resin, polyamide imide resin or polyesterimide resin.

8. The enameled wire containing a nano-filler as claimed in claim 1, wherein the layer of insulating coating comprising the nano-filler is prepared by adding the modified silicon dioxide slurry comprising 1 part by weight of silicon dioxide to 25 to 100 parts by weight of synthetic resin.

9. The enameled wire containing a nano-filler as claimed in claim 7, wherein the silicon dioxide has a specific surface area of 100 to 500 m²/g.

10. The enameled wire containing a nano-filler as claimed in claim 1 being applied to a frequency conversion motor.

11. The enameled wire containing a nano-filler as claimed in claim 1, wherein the organic solvent is phenols, hydrocarbon solvent, amides, esters, ketones, alcohols or a mixture thereof.

12. The enameled wire containing a nano-filler as claimed in claim 11, wherein phenols are phenol, cresol or xylenol and amides are N-methyl-2-pyrrolidone (NMP) or N,N-dimethyl acetamide (DMA).

13. The enameled wire containing a nano-filler as claimed in claim 4, wherein the synthetic resin is polyester resin, polyimide resin, polyurethane resin, polyamide imide resin or polyesterimide resin.

14. The enameled wire containing a nano-filler as claimed in claim 1, wherein the silicon dioxide has a specific surface area of 100 to 500 m²/g.
